(19) United States
(12) Patent Application Publication
(10) Pub. No.: US 2015/0115009 A1
(43) Pub. Date: Apr. 30, 2015

(54) Apparatus for Supporting an Electronic Device

(71) Applicant: Stauber Products LLC, Branchburg, NJ (US)

(72) Inventor: Leo F. Stauber, Branchburg, NJ (US)

(73) Assignee: Stauber Products LLC, Branchburg, NJ (US)

(21) Appl. No.: 14/062,012

(22) Filed: Oct. 24, 2013

(51) Int. Cl. B60R 7/04

(52) U.S. Cl. CPC B60R 7/043
USPC 224/275

(57) ABSTRACT

An apparatus is disclosed for supporting an electronic device, such as a laptop computer, a tablet computer, a smartphone, or an e-reader when travelling on a train or other public transportation. The apparatus is designed to fold into a portable, compact unit when not being used. The apparatus may be hung from a peg in the seatback in front of the user and is capable of folding out into an open position capable of supporting the electronic device. The device includes a seat bracket and two arms which open into a vee in order to support the electronic device. In one embodiment, the arms are telescopic in order to support electronic devices of differing sizes. In another embodiment, the arms have one or more rises which permits the electronic device to be support in a substantially upright position.

### TECHNICAL FIELD

The present disclosure generally relates to apparatuses which are adapted to hang on the peg of a seatback and to support an electronic device.

### BACKGROUND

As background, many people travel with their electronic devices, such as laptop computers, tablet computers, e-readers, smartphones, and the like. People often take advantage of the time they are travelling by using their electronic devices for work and/or for pleasure. During use, the user may hold the electronic device in his hands in order to achieve a suitable viewing angle. However, this may lead to fatigue or pain in the user's arms or hands. Alternatively, the user may rest the electronic device in his lap. But this can cause the user to angle his head at an awkward position in order to view the electronic device and may lead to pain in the user's neck or back. Thus, a solution is needed for people who want to comfortably use their electronic device while travelling.

### SUMMARY

An apparatus is disclosed for supporting an electronic device, the apparatus comprising a hanging mechanism, a seat bracket, a first telescoping arm, and a second telescoping arm, wherein: the hanging mechanism is mechanically coupled to the seat bracket and is adapted to be removably affixed to a peg in a seatback such that, when the hanging mechanism is affixed to the peg, the apparatus hangs down from the peg; the first telescoping arm and second telescoping arm are each adjustable to telescope between a retracted position and an extended position; and the first telescoping arm and the second telescoping arm are pivotally coupled to the seat bracket such that the first telescoping arm and the second telescoping arm are adapted to move between an open position and a closed position, wherein: when in the closed position, the first telescoping arm and the second telescoping arm are substantially parallel to and substantially proximate to the seat bracket; and when in the open position and when the apparatus hangs down from the peg: the first telescoping arm and the second telescoping arm are each adapted to pivot away from the seat bracket and to stop at a fixed angle with respect to the seat bracket; and the first telescoping arm and the second telescoping arm are adapted to move with respect to each other so as to form a vee adapted to support the electronic device.

In another embodiment, an apparatus is disclosed for supporting an electronic device, the apparatus comprising a hanging mechanism, a seat bracket, a first arm, and a second arm, wherein: the hanging mechanism is mechanically coupled to the seat bracket and is adapted to be removably affixed to a peg in a seatback such that, when the hanging mechanism is affixed to the peg, the apparatus hangs down from the peg; the first arm and the second arm are pivotally coupled to the seat bracket such that the first arm and the second arm are adapted to move between an open position and a closed position, wherein: when in the closed position, the first arm and the second arm are substantially parallel to and substantially proximate to the seat bracket; and when in the open position and when the apparatus hangs down from the peg: the first arm and the second arm are each adapted to pivot away from the seat bracket and to stop at a fixed angle with respect to the seat bracket; the first arm and the second arm are adapted to move with respect to each other so as to form a vee adapted to support the electronic device; and the first arm and second arm each comprise one or more risers mechanically coupled thereto, wherein the risers are each adapted to form an edge to support the electronic device in a substantially upright position.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference characters and in which:

FIG. 1 depicts an apparatus for supporting an electronic device according to one or more embodiments shown and described herein;

FIG. 2 illustrates an apparatus supporting an electronic device according to one or more embodiments shown and described herein;

FIG. 3 shows an apparatus for supporting an electronic device in a substantially upright position according to one or more embodiments shown and described herein;

FIG. 4 depicts an apparatus for supporting an electronic device in a substantially upright position according to one or more embodiments shown and described herein;

FIGS. 5, 6a, and 6b illustrate hanging mechanisms according to one or more embodiments shown and described herein;

FIG. 7 shows a side view of an apparatus for supporting an electronic device according to one or more embodiments shown and described herein;

FIG. 8 depicts a top view of an apparatus for supporting an electronic device according to one or more embodiments shown and described herein; and

FIG. 9 shows an apparatus for supporting an electronic device in the closed position according to one or more embodiments shown and described herein.

### DETAILED DESCRIPTION

The embodiments described herein generally relate to apparatuses for supporting an electronic device. The apparatus may be adapted to hang down from a peg in a seatback. The user may move the apparatus between an open position, in which it hangs down from the peg and supports the electronic device, and a closed position, in which the apparatus may be relatively compact and portable.

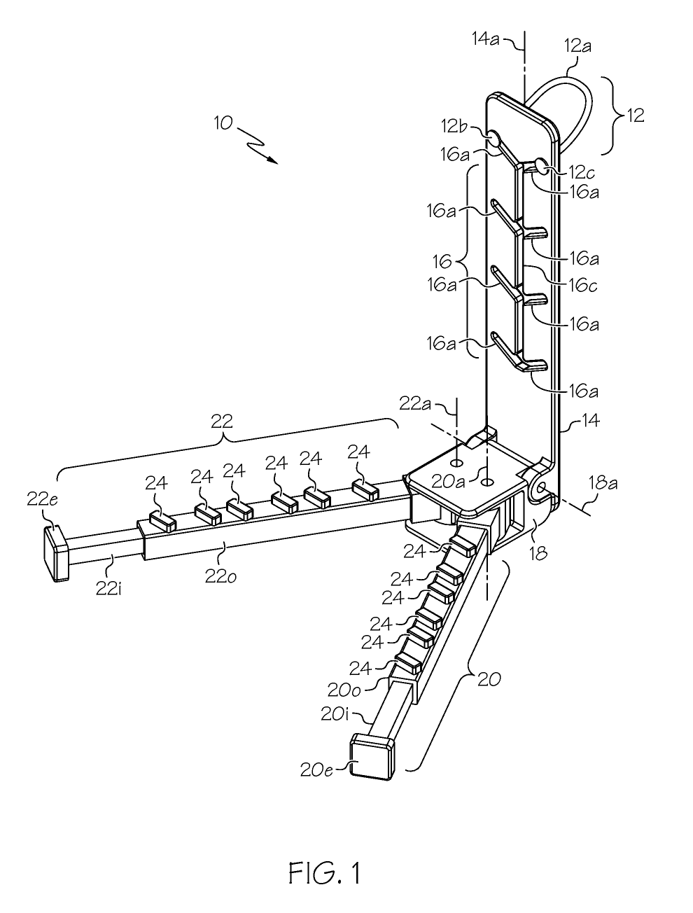

FIG. 1 shows one embodiment of an apparatus 10 which is adapted to support an electronic device (not shown). The apparatus 10 may comprise a hanging mechanism 12, a seat bracket 14, a first telescoping arm 20, and a second telescoping arm 22. The hanging mechanism 12 may be mechanically coupled to the seat bracket 14 and may be adapted to be removably affixed to a peg (not shown) in a seatback such that, when the hanging mechanism 12 is affixed to the peg, the apparatus 10 hangs down from the peg. The first telescoping arm 20 and second telescoping arm 22 may be each adjustable to telescope between a retracted position and an extended position. The first telescoping arm 20 and the second telescoping arm 22 may be pivotally coupled to the seat bracket 14 such that the first telescoping arm 20 and the second telescoping 22 arm are adapted to move between an open position and a closed position. For the purposes of this disclosure, “pivotally coupled” is defined as being mechanically coupled so as to permit angular movement around more than one axis. When in the closed position, the first telescoping arm 20 and the second telescoping arm 22 may be substantially parallel to and substantially proximate to the seat bracket 14. When in the open position, as shown in FIG. 1, and when the apparatus 10 hangs down from the peg, the first telescoping arm 20 and the second telescoping arm 22 may each be adapted to pivot away from the seat bracket 14 and to stop at a fixed angle with respect to the seat bracket 14. Also when in the open position, the first telescoping arm 20 and the second telescoping arm 22 are adapted to move with respect to each other so as to form a vee adapted to support the electronic device (not shown).

The hanging mechanism 12 may include numerous embodiments which permit the apparatus 10 to be affixed to the peg, and the hanging mechanism 12 depicted in FIG. 1 merely illustrates one exemplary embodiment. In this embodiment, the seat bracket 14 may comprise a slot 16, wherein the slot 16 may comprise a central slot 16c and a plurality of side slots 16a. The central slot 16c may be substantially parallel to a longitudinal axis 14a of the seat bracket 14. For the purposes of this disclosure, a “longitudinal axis” is defined as an axis that is substantially parallel to the longest side of an elongated object. Each of the side slots 16a may comprise a proximate end and a distal end. The proximate end of each of the plurality of side slots 16a may be contiguously coupled to the central slot 16c. Likewise, the distal end of each of the plurality of side slots 16a may be disposed at a plurality of locations proximate to the longitudinal axis 14a of the seat bracket 14. The central slot 16c and the plurality of side slots 16a may form a contiguous channel within the seat bracket 14 which, as described herein, may permit the apparatus 10 to be adjusted to various heights with respect to the peg on which it hangs. This may permit the user to adjust the viewing distance of the electronic device to suit his preference.

The hanging mechanism 12 may comprise a cord 12a mechanically coupled to at least one slider 12b, 12c. The at least one slider 12b, 12c may be slidingly coupled to the slot 16 such that the at least one slider 12b, 12c are captured by the slot 16 and are capable of sliding within the slot 16. The at least one slider 12b, 12c may be captured by the slot 16 in a way that allows it to slide along the central slot 16c and into any of the plurality of side slots 16a while preventing it from being removed from the slot 16. Accordingly, the at least one slider 12b, 12c may have a groove or other suitable means which permits it to be captured by the slot 16. As shown in FIG. 1, the at least one slider 12b, 12c is shown at the distal ends of two side slots 16a. In this embodiment, the user may slide the at least one slider 12b, 12c to the distal end of any of the side slots 16a in order adjust the height (i.e., distance) of the electronic device with respect to the peg.

In another embodiment, the hanging mechanism 12 may comprise only a single slider which is mechanically coupled to a cord which may have an eyelet suitable to be looped around the peg. This single slider may be slidingly moved along the slot 16 and may be disposed at the distal end of one of the side slots in order to adjust the height of the apparatus 10 with respect to the peg. However, in the embodiment shown in FIG. 1, the hanging mechanism 12 comprises two sliders 12b, 12c which are mechanically coupled to a cord 12a such that each slider 12b, 12c may be independently moved to the distal end of any of the side slots 16a in order to adjust the height of the apparatus 10 with respect to the peg. It is contemplated that other such means may also be used to adjust the height of the apparatus 10 as is known in the art.

The cord 12a may be constructed of metal, plastic, cloth, or other suitable material. The cord 12a may be flexible so as to permit it to be affixed to the peg by looping it around the peg in order to support the apparatus 10. In some instances, the peg may be recessed in the seatback so that the cord 12a may have to extend out from the seat bracket 14 in order for it to be affixed to the peg.

The seat bracket 14 may be constructed of metal, plastic, metal alloy, or any other suitable material. In one embodiment, the seat bracket 14 may be constructed of aluminum which may facilitate the inclusion of the slot 16. When the apparatus 10 hangs down from the peg, the seat bracket 14 may also hang down such that the longitudinal axis 14a of the seat bracket 14 is substantially parallel to the surface of the seatback.

The first telescoping arm 20 and the second telescoping arm 22 may be pivotally coupled to the seat bracket 14 such that the first telescoping arm 20 and the second telescoping arm 22 are adapted to move between an open position and a closed position. FIG. 1 depicts one embodiment in which the first telescoping arm 20 and the second telescoping arm 22 are pivotally coupled to the seat bracket 14 via a yoke 18. The yoke 18 may be hingedly coupled to the seat bracket 14 at a first axis 18a which permits the yoke 18 to hinge such that, when in the closed position, the first telescoping arm 20 and the second telescoping arm 22 are substantially parallel to and substantially proximate to the seat bracket 14. The yoke 18 and the seat bracket 14 may be mechanically coupled in such a way that the first telescoping arm 20 and the second telescoping arm 22 stop at a fixed angle with respect to the seat bracket 14 when in the open position. For the purposes of this disclosure, “hingedly coupled” is defined as being mechanically coupled so as to permit angular movement around one axis.

The first telescoping arm 20 may be hingedly coupled to the yoke 18 at a second axis 20a, and the second telescoping arm 22 may be hingedly coupled to the yoke 18 at a third axis 22a such that the first telescoping arm 20 and the second telescoping arm 22 are able to form a vee capable of supporting the electronic device. The second axis 20a and the third axis 22a may be substantially parallel so that the first telescoping arm 20 and the second telescoping arm 22 move with respect to each other in the same plane. The combined yoke 18, first axis 18a, second axis 20a, and third axis 22a may permit the first telescoping arm 20 and the second telescoping arm 22 to pivot between the open position and the closed position. Although this embodiment includes a yoke 18, it is contemplated that other techniques may be used to pivotally couple the first telescoping arm 20 and the second telescoping arm 22 to the seat bracket 14.

The first telescoping arm 20 may comprise an inner tube 20i and an outer tube 20o, which may be concentric and mechanically coupled to each other such that inner tube 20i slides inside the outer tube 20o when moving the first telescoping arm 20 between the retracted position and the extended position. The first telescoping arm 20 may also comprise a tube stop (not shown) which may prevent the inner tube 20i from sliding out of the outer tube 20o. The second telescoping arm 22 may likewise comprise an inner tube 22i and an outer tube 22o, and these may have the same features and operation as described herein for the first telescoping arm 20.

The first telescoping arm 20 may also comprise an end cap 20e mechanically coupled to a distal end thereof such that the end cap 20e is adapted to support the electronic device. Likewise, the second telescoping arm 22 may comprise an end cap 22e mechanically coupled to a distal end thereof. The end caps 20e, 22e may, in addition to supporting the electronic device, permit the user to easily extend the first telescoping arm 20 and the second telescoping arm by allowing the user to grasp the end caps 20e, 22e and pull. The end caps 20e, 22e may also provide a positive stop when the user fully retracts the first telescoping arm 20 and the second telescoping arm 22.

Continuing to refer to FIG. 1, the first telescoping arm 20 and the second telescoping arm 22 may each comprise one or more risers 24 mechanically coupled thereto, wherein the risers 24 may each be adapted to form an edge to support the electronic device in a substantially upright position. In this position, bottom edge of the electronic device may rest against the edge of two of the risers 24, and the top of the electronic device may lean against the seat bracket 14. The risers 24 may be paired so that they are disposed at approximately the same position on each the first telescoping arm 20 and the second telescoping arm 22. In this fashion, when the apparatus 10 is in the open position, the electronic device, when in a substantially upright position, may rest on one riser 24 on the first telescoping arm 20 and the corresponding riser 24 on the second telescoping arm 22. The multiple risers 24 may permit the user to adjust the angle of the electronic device to suit his viewing preference. If the risers 24 are elongated, as shown in FIG. 1, they may be disposed at an angle so that their elongated side is substantially parallel to the bottom edge of the electronic device when the apparatus is in the open position.

The risers 24 may also support the electronic device in a substantially flat position. As such, the risers 24 may comprise a kind of material which may reduce the likelihood of the electronic device from sliding around on the first telescoping arm 20 and the second telescoping arm 22 when the electronic device and the apparatus 10 are exposed to the normal vibrations and motions produced by the vehicle (e.g., a train car as it travels along its track). The top of the end caps 20e, 22e and the tops of the risers 24 may be adapted so as to form a plane to support the electronic device in a substantially flat position.

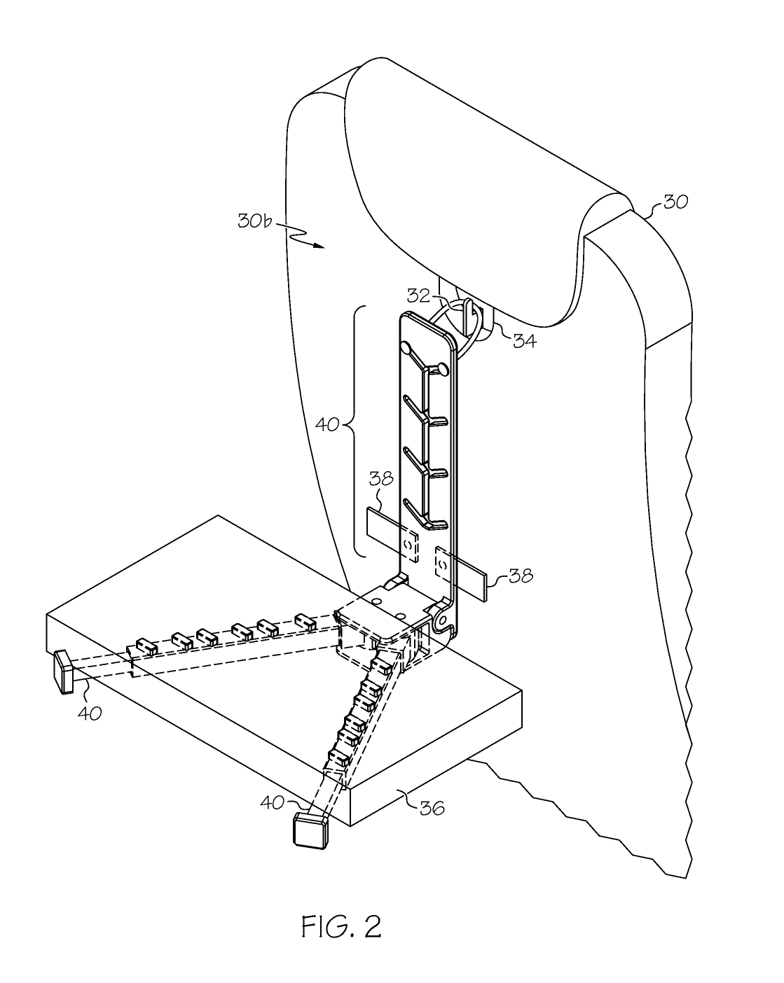

Referring to FIG. 2, one embodiment of the apparatus 40 for supporting an electronic device 36 is illustrated in the open position while hanging on a peg 32 in a seatback 30b. The seatback 30b may be part of a seat 30 in a train car, bus, or other type of vehicle. The user of the apparatus 40 may be disposed in another seat (not shown) that is behind the seat 30 and its associated seatback 30b. The user may affix the apparatus 40 to the peg 32 in the seatback 30b and may configure the apparatus 40 in the open position, as shown in FIG. 2. In this embodiment of the apparatus 40, the arms may be telescopic such that they may extend from a refracted position to an extended position. As such, the telescopic arms may permit the electronic device 36 to be supported by the apparatus 40 in a substantially flat position. As used in this disclosure, the phrase “substantially flat position” defines the position of the electronic device when it lay on the arms, as depicted in FIG. 2. This may also include electronic devices which have a hinged display, such as laptop computers.

The apparatus 40 may also comprise one or more braces 38 which may be hingedly coupled to the seat bracket as depicted in FIG. 2. The one or more braces 38 may be adapted to move between a first position and a second position, wherein: when in the first position, the one or more braces 38 are substantially parallel to and substantially proximate to the seat bracket; and when in the second position, the one or more braces 38 are substantially perpendicular to the seat bracket and are adapted to engage the seatback 30b so as to reduce the likelihood of movement of the electronic device 36 with respect to the seatback 30b. Such movement may arise from the normal vibrations and motions produced by the vehicle (e.g., a train car as it travels along its track). The one or more braces 38 may be moved to the first position when the apparatus 40 is moved to its closed position so as to make the apparatus 40 as compact as possible. Likewise, the one or more braces 38 may be moved to the second position when the apparatus 40 is moved to its open position, as illustrated in FIG. 2.

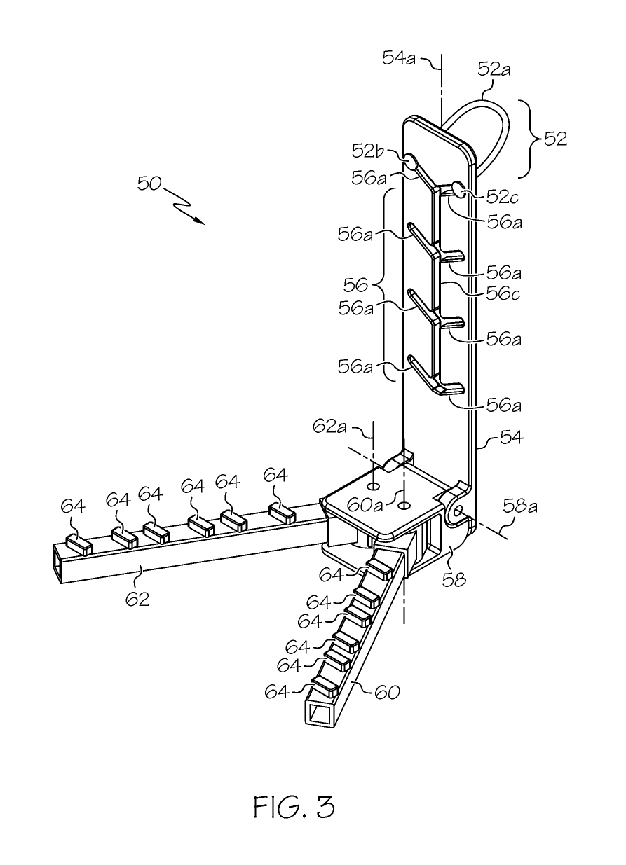

FIG. 3 illustrates another embodiment of an apparatus 50 capable of supporting an electronic device (not shown). The apparatus 50 may comprise a hanging mechanism 52, a seat bracket 54, a first arm 60, and a second arm 60. The hanging mechanism 52 may be mechanically coupled to the seat bracket 54 and may be adapted to be removably affixed to a peg (not shown) in a seatback such that, when the hanging mechanism 52 is affixed to the peg, the apparatus 50 hangs down from the peg. The first arm 60 and the second arm 62 may be pivotally coupled to the seat bracket 54 such that the first arm 60 and the second arm 62 are adapted to move between an open position and a closed position. When in the closed position, the first arm 60 and the second arm 62 may be substantially parallel to and substantially proximate to the seat bracket 54. When in the open position and when the apparatus 50 hangs down from the peg, the first arm 60 and the second arm 62 may each be adapted to pivot away from the seat bracket 54 and to stop at a fixed angle with respect to the seat bracket 54. The first arm 60 and the second arm 62 may be adapted to move with respect to each other so as to form a vee adapted to support the electronic device. The first arm 60 and second arm 62 may each comprise one or more risers 64 mechanically coupled thereto, wherein the risers 64 are each adapted to form an edge to support the electronic device in a substantially upright position.

The seat bracket 54 may include a slot 56 which may comprise a central slot 56c and a plurality of side slots 56a. The central slot 56c and the plurality of side slots 56a may form a contiguous channel. The hanging mechanism 52 may comprise a cord 52a mechanically coupled to at least one slider 52b, 52c. The at least one slider 52b, 52c may be slidingly coupled to the slot 56 such that the at least one slider 52b, 52c are captured by the slot 56 and are capable of sliding within the slot 56. This may permit the user to adjust the height of the electronic device with respect to the peg as discussed herein with respect to FIG. 1.

The apparatus embodied in FIG. 3 may also comprise a yoke 58 which may be hingedly coupled to the seat bracket 54 at a first axis 58a. The first arm 60 may be hingedly coupled to the yoke 58 at a second axis 60a, and the second arm 62 may be hingedly coupled to the yoke 58 at a third axis 62a. The yoke 58 may permit the first arm 60 and the second arm 62 to be pivotally coupled to the seat bracket 54 in a similar fashion to the yoke, first telescoping arm, and second telescoping arm discussed herein with respect to FIG. 1.

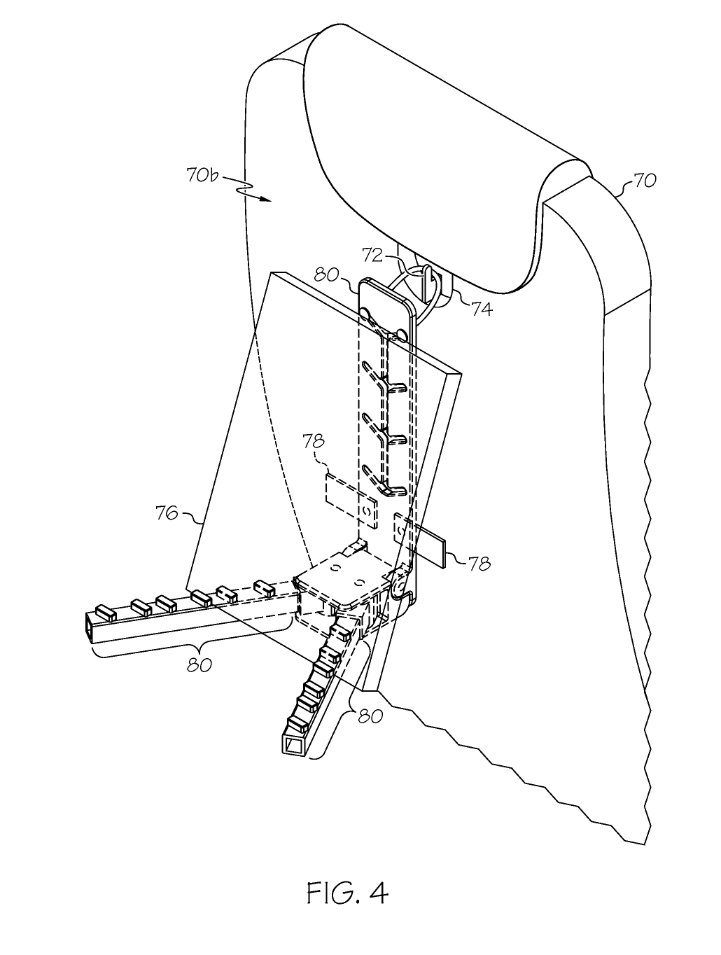

Turning now to FIG. 4, one embodiment of the apparatus 80 is illustrated in the open position while hanging on a peg 72 in a seatback 70b. The seatback 70b may be part of a seat 70 in a train car, bus, or other type of vehicle. The user of the apparatus 80 may be disposed in another seat (not shown) that is behind the seat 70 and its associated seatback 70b. The user may affix the apparatus 80 to the peg 72 in the seatback 70b and may configure the apparatus 80 in the open position, as shown in FIG. 4. In this embodiment of the apparatus 80, the arms may comprise risers which permit the electronic device 76 to be supported by the apparatus 80 in a substantially upright position. As used in this disclosure, the phrase “substantially upright position” defines the position of the electronic device when the bottom of the electronic device is supported by the risers on the arms, and the top of the electronic device leans against the seat bracket, as depicted in FIG. 4.

The risers on the arms may be paired so that, when in the open position, each pair of risers provides an edge against which the bottom edge of the electronic device 76 may rest. As shown in FIG. 4, each pair of risers may be disposed on the arms at multiple locations along the length of the arms so as to accommodate electronic devices of different sizes. Also, the multiple pairs of risers permit the user to adjust the angle of the electronic device 76 to suit his viewing angle. A cushion (not shown) may be disposed on the front side of the seat bracket such that the top of electronic device, when in the substantially upright position, rests against the cushion. This cushion may provide a relatively soft surface on which the electronic device may rest in order to reduce the effects of vibration and/or shock. Also, the cushion may also comprise a type of material with a relatively high degree of friction which may reduce the likelihood of the electronic device 76 from moving around when being used.

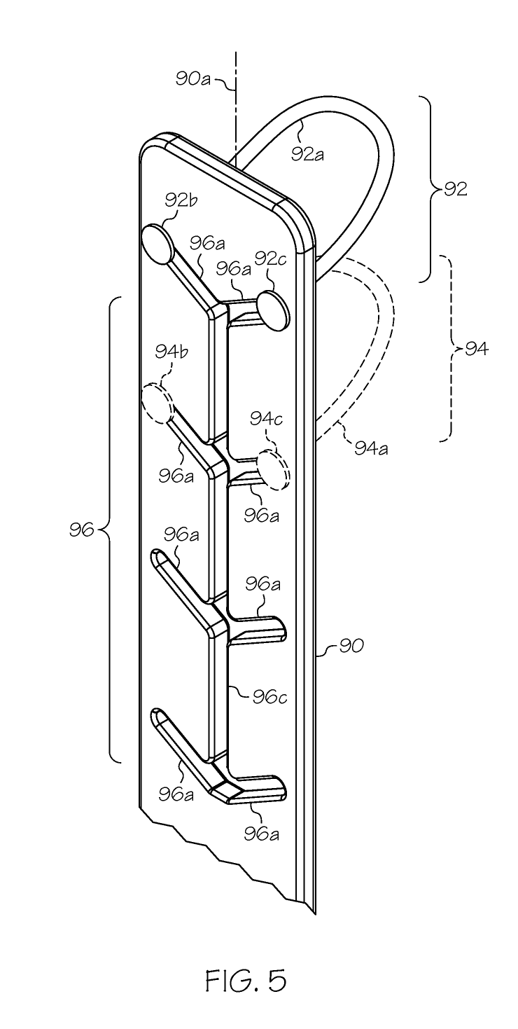

One embodiment of a hanging mechanism 92 is shown in FIG. 5. In this figure, the remaining parts of the apparatus are omitted for clarity. In this embodiment, the seat bracket 90 may comprise a slot 96 which may comprise a central slot 96c and a plurality of side slots 96a. The central slot 96c may be substantially parallel to a longitudinal axis 90a of the seat bracket 90. Each of the plurality of side slots 96a may comprise a proximate end and a distal end, wherein the proximate end of each of the plurality of side slots 96a is contiguously coupled to the central slot 96c. The distal ends of each of the plurality of side slots 96a may be disposed at a plurality of locations proximate to the longitudinal axis 90a of the seat bracket 90. As shown in FIG. 5, the distal ends of the side slots 16a may be angled upward. The side slots 96a may be substantially straight (as shown), they may be arced, or they may assume any other suitable geometry.

Continuing to refer to FIG. 5, the hanging mechanism 92 may comprise a cord 92a mechanically coupled to at least one slider 92b, 92c, wherein the at least one slider 92b, 92c is slidingly coupled to the slot 96 such that, when the apparatus is in the open position, the height of the electronic device with respect to the peg is adjusted by sliding the at least one slider 92b, 92c to the distal end of at least one of the plurality of side slots 96a. In the embodiment shown, there are two sliders 92b, 92c, each of which may be slid independent in the slot 96. The user may move the sliders 92b, 92c to the distal end of the side slots 96a in order to adjust the height of the apparatus with respect to the peg. As shown, the sliders 92b, 92c are disposed in the topmost side slots 96a so that the height of the apparatus (and the corresponding electronic device supported by the apparatus) is at the lowest point with respect to the peg. FIG. 5 also illustrates the hanging mechanism 94 when it is adjusted to a different height. Here, the sliders 94b, 94c are disposed in the distal end of another set of sliders 96a which adjusts the height of the apparatus to its next-to-lowest point with respect to the peg.

The side slots 96a may be paired, as depicted in FIG. 5, so that each pair of side slots 96a may be contiguously coupled to the central slot 96c at substantially the same location. In this embodiment, the central slot 96c may be disposed near the actual physical center of the seat bracket 90, and the side slots 96a (or pairs of side slots 96a) may disposed on each side of the central slot 96c. However, other embodiments of this type of hanging mechanism are contemplated. For example, the hanging mechanism may only comprise one slider mechanically coupled to a cord which may be in the shape of a loop. In this example, the central slot may be disposed near the edge of the seat bracket 90, and the distal ends of the side slots may be disposed near the center of the seat bracket 90. In this fashion, the single slider may be moved to the distal end of one of the side slots in order to adjust the height of the apparatus with respect to the peg.

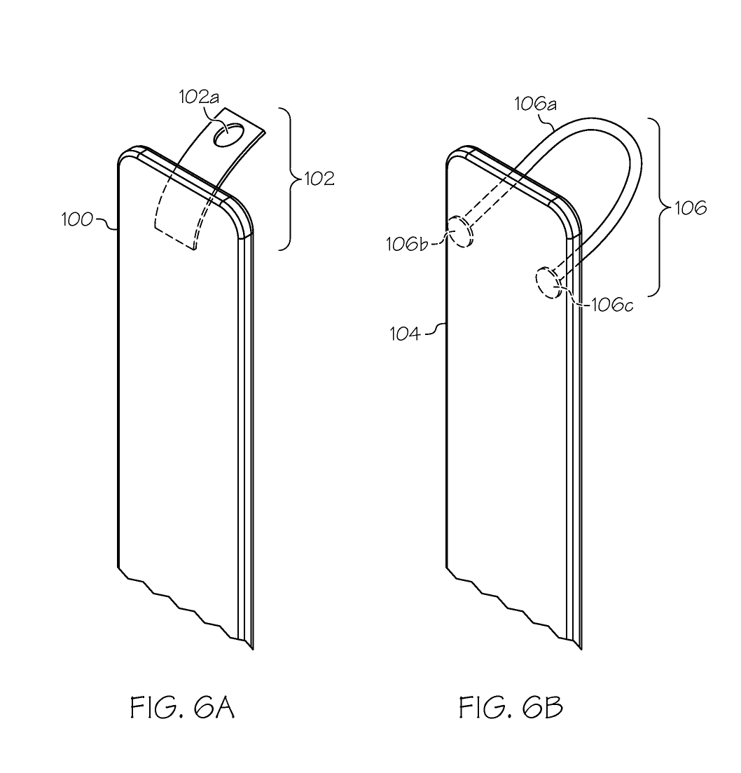

FIGS. 6a and 6b show two alternative embodiments for the hanging mechanism. In these figures, the remaining parts of the apparatus are omitted for clarity. In FIG. 6a, the hanging mechanism 102 comprises a hanging bracket 102 having a hole 102a. The hanging bracket 102 may be mechanically coupled to the seat bracket 100 and may protrude from the seat bracket 100 so that it may be affixed to a peg (not shown) which may be recessed in the seatback. The hole 102a may be of sufficient size so that the peg may be inserted through it when affixing the apparatus to the peg. Also the hole 102a may be circular (as shown) or may be elongated, tapered, or any other suitable shape. The hanging bracket 102 may be constructed of metal, alloy, plastic, or another other suitable material. The hanging bracket 102 may also be rigid, semi-rigid, or flexible. The hanging bracket 102 may be mechanically coupled to the seat bracket 100 by welding, gluing, or any other appropriate method, including using various types of fasteners (e.g., screws, nuts and bolts, rivets, etc.) The hanging bracket 102 may be mechanically coupled to the back of the seat bracket 100 as shown.

In another embodiment, the seat bracket 100 itself may be designed so that the hanging mechanism is formed directly from the seat bracket 100. For example, the top portion of seat bracket may be angled toward the peg so that this angled portion of the seat bracket becomes the hanging mechanism. This angled portion of the seat bracket may comprise a hole through which the peg may be inserted when affixing the apparatus to the peg. This may be a relatively simple to manufacturer since the angled portion of the seat bracket may be formed when the seat bracket is fabricated. Although this may be relatively simple to implement, this embodiment may not afford the user the possibility of adjusting the height of the apparatus to accommodate people of different sizes and different peg locations in the seatback.

FIG. 6b depicts yet another embodiment of the hanging mechanism 106, which may comprise a cord 106a mechanically coupled to the seat bracket 104 in one or more locations. As shown in FIG. 6b, the cord 106a may be mechanically coupled to the seat bracket at locations 106b, 106c. The cord 106a may be welded, glued, or otherwise affixed to the seat bracket 104 at these locations 106b, 106c. The cord 106a may be constructed of metal, plastic, cloth, or any other suitable material, and it may be flexible or semi-flexible. The locations 106b, 106c at which the cord 106a is mechanically coupled to the seat bracket 104 may be disposed on the back side of the seat bracket 104. Like the embodiment shown in FIG. 6a, the embodiment of the hanging mechanism 106 shown in FIG. 6b may be relatively simple to manufacture, but it may not afford the user the possibility of adjusting the height of the apparatus with respect to the peg.

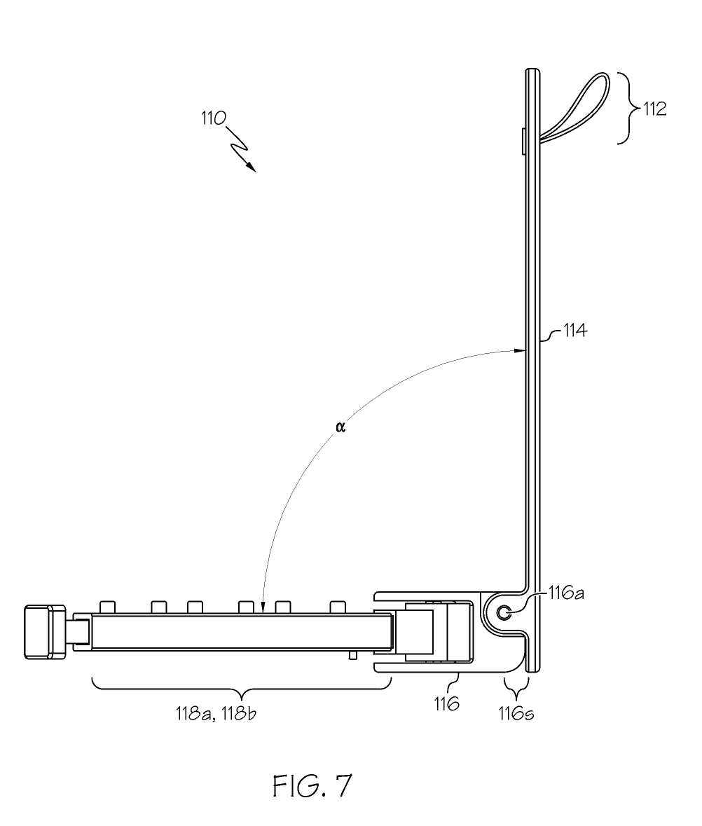

Turning to FIG. 7, a side view of the apparatus 110 is shown. The apparatus 110 may comprise a hanging mechanism 112, a seat bracket 114, a yoke 116, and two arms 118a, 118b. The yoke 116 may be hingedly coupled to the seat bracket 114 at a first axis 116a so that the arms 118a, 118b are adapted to move between an open position and a closed position. As shown in FIG. 7, the arms 118a, 118b are in the open position. The angle a may indicate the angle between the seat bracket 114 and the arms 118a, 118b. When in the closed position, a may be substantially zero, and the arms 118a, 118b may be substantially parallel to and proximate to the seat bracket 114. When in the open position, a may be limited to a fixed angle. This may permit the arms 118a, 118b to assume a relatively fixed position with respect to the seat bracket 114 so as to support the electronic device.

In the embodiment illustrated in FIG. 7, a may be limited to a fixed angle by the way the yoke 116 is hingedly coupled to the seat bracket 114. As shown, the first axis 116a may be disposed in such a way to create a yoke stop 116s. This may be accomplished by placing the location of the first axis 116a above the center line of the yoke 116. In this fashion, the mechanical interference of the yoke 116 and the seat bracket 114 creates a yoke stop 116s when a reaches a predetermined fixed angle. This fixed angle may be any suitable value such as, for example, between 60 degrees and 120 degrees. The design of the seat bracket 114 and the yoke 116 may establish this fixed angle. It should be understood that a may be limited to a fixed angle via any number of suitable techniques, as is known in the arts.

The optimal value of a may depend on the angle of the seatback. Accordingly, the fixed angle of the arms 118a, 118b with respect to the seat bracket 114 when in the open position may depend on the specific type of vehicle (e.g., train car). As an example, for Bombardier MultiLevel Coach trains (see www.bomardier.com), the fixed angle may be about 70 degrees. For other types of trains, the fixed angle may be more or less. The selection of a fixed angle for a may also be adjustable by the user. For example, a screw (not shown) may be inserted through the seat bracket 114 at the yoke stop 116s which may be adjustable by the user. The arms 118a, 118b may or may not be retractable and extendable.

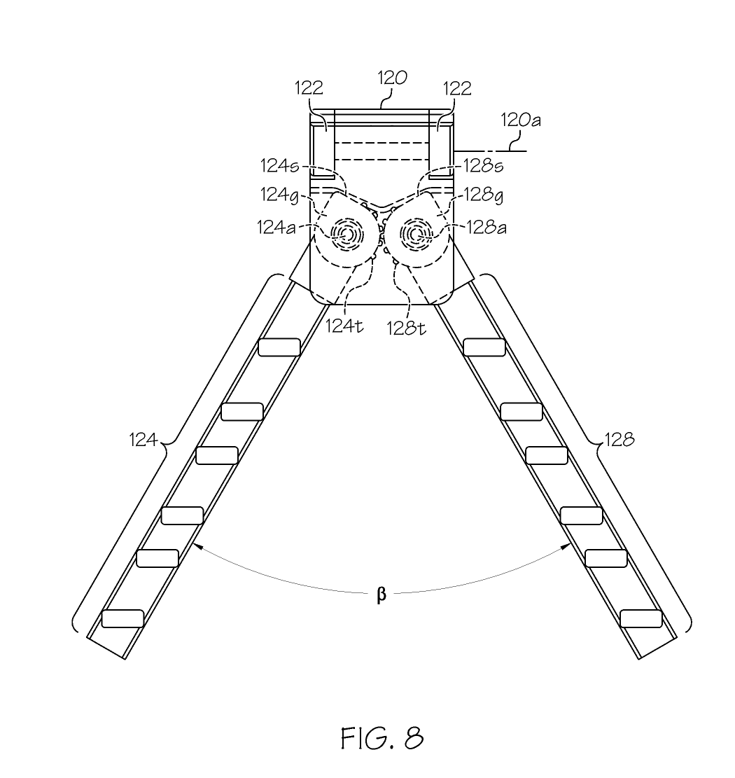

Referring to FIG. 8, a top view of the apparatus for supporting an electronic device is depicted, showing a vee stop and an arm synchronizer according to one embodiment of the invention. In FIG. 8, only the yoke 120, a portion of the seat bracket 122, the first arm 124, and the second arm 128 are shown. The other parts of the apparatus are omitted for clarity. The yoke 120 may be hingedly coupled to the seat bracket 122 at the first axis 120a. The first arm 124 may be hingedly coupled to the yoke 120 at a second axis 124a. The first arm 124 may hinge about the second axis 124a when moving between the open position and the closed position. Likewise, the second arm 128 may be hingedly coupled to the yoke 120 at a third axis 128a. The second arm 128 may hinge about the third axis 128a when moving between the open position and the closed position. In this figure, the view is parallel to the longitudinal axis of the seat bracket 122, the portion of which shown that is pivotally coupled to the yoke 120. The yoke 120 may hinge with respect to the seat bracket 122 at the first pivot axis 120a.

The first arm 124 and the second arm 128 may form a vee when in the open position, and the angle between the first arm 124 and the second arm 128 may be denoted β, as shown in FIG. 8. The value of β may be substantially zero when in the closed position, and may range between about 25 to 90 degrees when in the open position. In one embodiment, the value of β may be about 60 degrees. It may be advantageous to limit β when in the open position. For example, if β became too large, the first arm 124 and the second arm 128 may be too far apart to adequately support the electronic device. Also, if β was limited to a fixed angle, the risers disposed on the first arm 124 and the second arm 128 may substantially align in order to support the electronic device in a substantially upright position. Accordingly, the apparatus may include a vee stop which may limit β to a fixed angle.

In FIG. 8, the vee stop comprises a stop 124s mechanically coupled to the first arm 124 and a stop 128s mechanically coupled to the second arm 128. The stops 124s, 128s may provide a mechanical interference such that the first arm 124 and the second arm 128 are limited to a fixed angle when in the open position. That is, when the first arm 124 and the second arm 128 are opened to the fixed angle, the stops 124s, 128s may come in contact and prevent β from exceeding the fixed angle. In one embodiment, the fixed angle may be about 30 degrees. Other fixed angles may be utilized as well. Other techniques may be used to implement the vee stop, as is known in the art.

FIG. 8 also shows an arm synchronizer according to one embodiment of the inventions. The arm synchronizer may comprise a first gear 124g mechanically coupled to the first arm 124 and a second gear 128g mechanically coupled to the second arm 128. The first gear 124g may be concentric with the second axis 124a of the first arm 124, and the second gear 128g may be concentric with the third axis 128a of the second arm 128. The first gear 124g may comprise one or more teeth 124t, and the second gear 128g may also comprise one or more teeth 128t. The teeth 124t, 128t may be mechanically coupled to each other such that the first arm 124 and the second arm 128 synchronously hinge about their respective axes. That is, when moving from the closed position (in which β may be substantially zero) to the open position (in which β may be a fixed angle), the first arm 124 and the second arm 128 may move angularly in a synchronous manner.

The arm synchronizer may permit the user to move the arms 124, 128 of the apparatus from the closed position to the open position in a consistent fashion. Without the arm synchronizer, the first arm 124 and the second arm 128 may move independently of each other. Accordingly, it may require the user to consciously observe whether the first arm 124 and the second arm 128 are open to a sufficient degree necessary to support the electronic device. Synchronizing the movement of the arms 124, 128, along with a vee stop (described herein) may allow the user to simply open either the first arm 124 or the second arm 128 until it reaches the angular limit (as defined by the vee stop) to recognize that the apparatus is in the fully open position. As such, this may provide a convenient way for the user to configure the apparatus to the open position. The arm synchronizer shown in FIG. 8 is only one possible embodiment; it is contemplated that other techniques may be used to coordinate the movement of the first arm 124 with respect to the second arm 128.

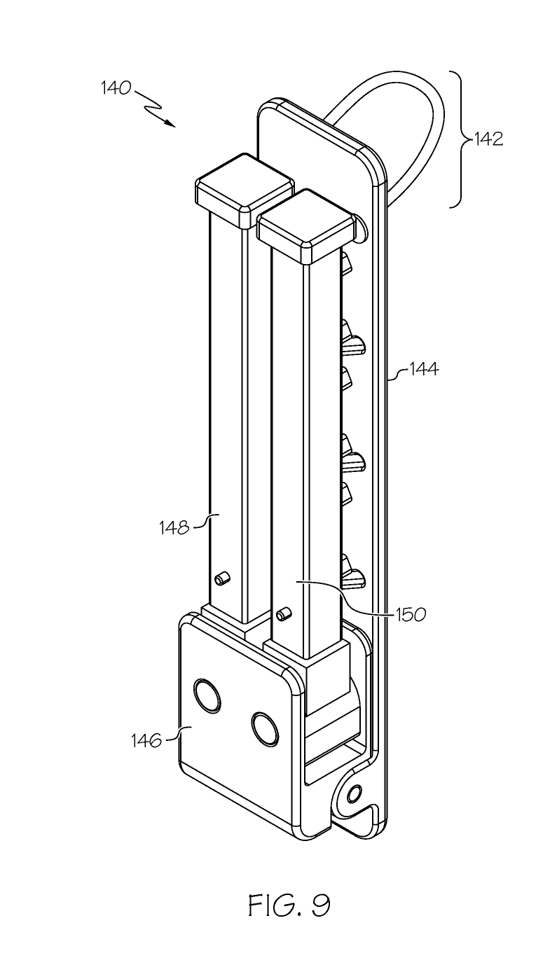

Turning to FIG. 9, an apparatus 140 for supporting an electronic device is shown comprising a hanging mechanism 142, a seat bracket 144, a yoke 146, a first arm 148 and a second arm 150. In this figure, the first arm 148 and the second arm 150 are shown in the closed position, in which the first arm 148 and the second arm 150 are substantially parallel to and substantially proximate to the seat bracket 144. When in the closed position, the apparatus 140 may assume a relatively compact shape so as to make it portable. As such, the apparatus 140 may be easily stowed in a purse, handbag, suitcase, or other similar device.

As shown in FIG. 9, the first arm 148 and second arm 150 may be telescoping arms or may be non-telescoping arms, as described herein. If the arms are telescoping, the first arm 148 and the second arm 150 may be moved to the retracted position so as to make the apparatus 140 as small as possible in the closed position. The apparatus 140 may also include a strap or elastic band (not shown) to secure the first arm 148 and the second arm 150 in the closed position. As an alternative, the apparatus 140 may comprise one or more magnets which secure the first arm 148 and the second arm 150 in the closed position. As yet another alternative, the three hinging axes on the yoke 146 may have sufficient friction so that the first arm 148 and the second arm 150 remain in the closed position after the user has configured the apparatus 140 in this position. It is contemplated that other methods may be used, as is known in the art, to secure the first arm 148 and the second arm 150 in the closed position. It should also be noted that the apparatus 140 does not necessarily require a mechanism to insure that it remain in the closed position.

The user may configure the apparatus 140 move from the open position (e.g., as illustrated in FIGS. 1 and 3, for example) to the closed position as depicted in FIG. 9. When in the open position, the apparatus 140 may be affixed to a peg in a seatback so as to support an electronic device, either in a substantially flat position (as shown in FIG. 2) or in a substantially upright position (as shown in FIG. 4). When the user has finished using the apparatus 140, he may remove the electronic device, remove the apparatus 140 from the peg, and move the first arm 148 and the second arm 150 to the closed position, as shown in FIG. 9. The user may do this by moving the first arm 148 and the second arm 150 to the refracted position if they are telescoping arms. The user may then move the first arm 148 and the second arm 150 to the closed position, so that they are substantially parallel to and proximate to the seat bracket 144. When in the closed position, the apparatus 140 may be relatively compact and portable, and the user may be able to stow the apparatus 140 in a purse or handbag.

Likewise, the user may configure the apparatus 140 to move from the closed position, as shown in FIG. 9, to the open position (e.g., as illustrated in FIGS. 1 and 3, for example). In doing so, the user may pull the apparatus 140 from the purse, handbag, briefcase, etc., in which the apparatus 140 has been stowed in the closed position. The user may then move the first arm 148 and the second arm 150 to the open position. If the arms are telescoping, the user may move the first arm 148 and the second arm 150 to any position between the retracted position and the open position, inclusive. The user may do this to adjust the first arm 148 and the second arm 150 to accommodate the size of the electronic device. The user may then affix the hanging mechanism 142 to the peg in the seatback so that the peg supports the apparatus 140. The user may then place the electronic device on the apparatus 140 so that the apparatus 140 supports the electronic device. The electronic device may be placed on the first arm 148 and the second arm 150 either in a substantially flat position or a substantially upright position, as discussed herein. The user may then turn on the electronic device and begin using it.

While particular embodiments and aspects of the present invention have been illustrated and described herein, various other changes and modifications may be made without departing from the spirit and scope of the invention. Moreover, although various inventive aspects have been described herein, such aspects need not be utilized in combination. It is therefore intended that the appended claims cover all such changes and modifications that are within the scope of this invention.

What is claimed is:

1. An apparatus for supporting an electronic device, the apparatus comprising a hanging mechanism, a seat bracket, a first telescoping arm, and a second telescoping arm, wherein:
the hanging mechanism is mechanically coupled to the seat bracket and is adapted to be removably affixed to a peg in a seatback such that, when the hanging mechanism is affixed to the peg, the apparatus hangs down from the peg;
the first telescoping arm and second telescoping arm are each adjustable to telescope between a retracted position and an extended position; and
the first telescoping arm and the second telescoping arm are pivotally coupled to the seat bracket such that the first telescoping arm and the second telescoping arm are adapted to move between an open position and a closed position, wherein:
when in the closed position, the first telescoping arm and the second telescoping arm are substantially parallel to and substantially proximate to the seat bracket; and
when in the open position and when the apparatus hangs down from the peg:
the first telescoping arm and the second telescoping arm are each adapted to pivot away from the seat bracket and to stop at a fixed angle with respect to the seat bracket; and
the first telescoping arm and the second telescoping arm are adapted to move with respect to each other so as to form a vee adapted to support the electronic device.

2. The apparatus of claim 1, wherein the hanging mechanism comprises a hanging bracket, wherein the hanging bracket comprises a hole such that the hanging bracket is adapted to be removably affixed to the peg by inserting the peg through the hole.

3. The apparatus of claim 1, wherein the hanging mechanism comprises a flexible cord adapted to be removably looped around the peg.

4. The apparatus of claim 1, wherein the hanging mechanism is adapted to be adjustable along a longitudinal axis of the seat bracket such that, when the apparatus is in the open position, the height of the electronic device with respect to the peg is adjustable.

5. The apparatus of claim 4, wherein:
the seat bracket comprises a slot comprising a central slot and a plurality of side slots, wherein:
the central slot is substantially parallel to the longitudinal axis of the seat bracket;
each of the plurality of side slots comprise a proximate end and a distal end;
the proximate end of each of the plurality of side slots is contiguously coupled to the central slot; and
the distal ends of each of the plurality of side slots are disposed at a plurality of locations proximate to the longitudinal axis of the seat bracket; and
the hanging mechanism comprises a cord mechanically coupled to at least one slider, wherein the at least one slider is slidingly coupled to the slot such that, when the apparatus is in the open position, the height of the electronic device with respect to the peg is adjusted by sliding the at least one slider to the distal end of at least one of the plurality of side slots.

6. The apparatus of claim 5, wherein the apparatus further comprises a vee stop and an arm synchronizer, wherein:
the vee stop is mechanically coupled to the first telescoping arm and to the second telescoping arm and is adapted to limit the angle of the vee formed by the first telescoping arm and the second telescoping arm; and
the arm synchronizer is mechanically coupled to the first telescoping arm and the second telescoping arm and is adapted to synchronize the angular movement of the first telescoping arm and the second telescoping arm when forming the vee.

7. The apparatus of claim 6, wherein the first telescoping arm and the second telescoping arm each comprise one or more risers mechanically coupled thereto, wherein the risers are each adapted to form an edge to support the electronic device in a substantially upright position.

8. The apparatus of claim 1 further comprising a vee stop, wherein the vee stop is mechanically coupled to the first telescoping arm and the second telescoping arm and is adapted to limit the angle of the vee formed by the first telescoping arm and second telescoping arm.

9. The apparatus of claim 8 further comprising an arm synchronizer, wherein the arm synchronizer is mechanically coupled to the first telescoping arm and the second telescoping arm and is adapted to synchronize the angular movement of the first telescoping arm and the second telescoping arm when forming the vee.

10. The apparatus of claim 1 further comprising an arm synchronizer, wherein the arm synchronizer is mechanically coupled to the first telescoping arm and the second telescoping arm and is adapted to synchronize the angular movement of the first telescoping arm and the second telescoping arm when forming the vee.

11. The apparatus of claim 1, wherein the first telescoping arm and the second telescoping arm each comprise one or more risers mechanically coupled thereto, wherein the risers are each adapted to form an edge to support the electronic device in a substantially upright position.

12. The apparatus of claim 11, wherein the first telescoping arm and the second telescoping arm each comprise an end cap mechanically coupled to a distal end thereof, wherein the end cap is adapted to support the electronic device.

13. The apparatus of claim 1, wherein the first telescoping arm and the second telescoping arm each comprise an inner tube, and outer tube, and a tube stop, wherein:
the inner tube and outer tube are concentric and are mechanically coupled to each other such that inner tube slides inside the outer tube when moving between the retracted position and the extended position; and
the tube stop is mechanically coupled to the inner tube so as to prevent the inner tube from sliding out of the outer tube.

14. The apparatus of claim 1 further comprising a yoke, an arm synchronizer, and a vee stop, wherein:
the yoke is hingedly coupled to the seat bracket;
the first telescoping arm and the second telescoping arm are hingedly coupled to the yoke;
the arm synchronizer is mechanically coupled to the first telescoping arm and the second telescoping arm and is adapted to synchronize the angular movement of the first telescoping arm and the second telescoping arm when forming the vee;
the vee stop is mechanically coupled to the first telescoping arm and the second telescoping arm and is adapted to limit the angle of the vee formed by the first telescoping arm and the second telescoping arm; and
the first telescoping arm and the second telescoping arm each comprise one or more risers mechanically coupled thereto, wherein the risers are each adapted to form an edge to support the electronic device in a substantially upright position.

15. The apparatus of claim 1 further comprising one or more braces hingedly coupled to the seat bracket, wherein the one or more braces are adapted to move between a first position and a second position, wherein:
when in the first position, the one or more braces are substantially parallel to and substantially proximate to the seat bracket; and
when in the second position, the one or more braces are substantially perpendicular to the seat bracket and are adapted to engage the seatback so as to reduce the likelihood of movement of the electronic device with respect to the seatback.

16. An apparatus for supporting an electronic device, the apparatus comprising a hanging mechanism, a seat bracket, a first arm, and a second arm, wherein:
the hanging mechanism is mechanically coupled to the seat bracket and is adapted to be removably affixed to a peg in a seatback such that, when the hanging mechanism is affixed to the peg, the apparatus hangs down from the peg;
the first arm and the second arm are pivotally coupled to the seat bracket such that the first arm and the second arm are adapted to move between an open position and a closed position, wherein:
when in the closed position, the first arm and the second arm are substantially parallel to and substantially proximate to the seat bracket; and
when in the open position and when the apparatus hangs down from the peg:
the first arm and the second arm are each adapted to pivot away from the seat bracket and to stop at a fixed angle with respect to the seat bracket;
the first arm and the second arm are adapted to move with respect to each other so as to form a vee adapted to support the electronic device; and
the first arm and second arm each comprise one or more risers mechanically coupled thereto, wherein the risers are each adapted to form an edge to support the electronic device in a substantially upright position.

17. The apparatus of claim 16, wherein the hanging mechanism comprises a hanging bracket, wherein the hanging bracket comprises a hole such that the hanging bracket is adapted to be removably affixed to the peg by inserting the peg through the hole.

18. The apparatus of claim 16, wherein the hanging mechanism comprises a flexible cord adapted to be removably looped around the peg.

19. The apparatus of claim 16, wherein the hanging mechanism is adapted to be adjustable along a longitudinal axis of the seat bracket such that, when the apparatus is in the open position, the height of the electronic device with respect to the peg is adjustable.

20. The apparatus of claim 19, wherein:
the seat bracket comprises a slot comprising a central slot and a plurality of side slots, wherein:
the central slot is substantially parallel to the longitudinal axis of the seat bracket;
each of the plurality of side slots comprise a proximate end and a distal end;
the proximate end of each of the plurality of side slots is contiguously coupled to the central slot; and
the distal ends of each of the plurality of side slots are disposed at a plurality of locations proximate to the longitudinal axis of the seat bracket; and
the hanging mechanism comprises a cord mechanically coupled to at least one slider, wherein the at least one slider is slidingly coupled to the slot such that, when the apparatus is in the open position, the height of the electronic device with respect to the peg is adjusted by sliding the at least one slider to the distal end of at least one of the plurality of side slots.

21. The apparatus of claim 20, wherein the apparatus further comprises a vee stop and an arm synchronizer, wherein:
the vee stop is mechanically coupled to the first arm and to the second arm and is adapted to limit the angle of the vee formed by the first arm and the second arm; and
the arm synchronizer is mechanically coupled to the first arm and the second arm and is adapted to synchronize the angular movement of the first arm and the second arm when forming the vee.

22. The apparatus of claim 16, wherein the apparatus further comprises a vee stop, wherein the vee stop is mechanically coupled to the first arm and to the second arm and is adapted to limit the angle of the vee formed by the first arm and the second arm

23. The apparatus of claim 22, wherein the apparatus further comprises an arm synchronizer, wherein the arm synchronizer is mechanically coupled to the first arm and the second arm and is adapted to synchronize the angular movement of the first arm and the second arm when forming the vee.

24. The apparatus of claim 16 further comprising an arm synchronizer, wherein the arm synchronizer is mechanically coupled to the first arm and the second arm and is adapted to synchronize the angular movement of the first arm and the second arm when forming the vee.
